(19) United States
(12) Patent Application Publication
(10) Pub. No.: US 2013/0186504 A1
(43) Pub. Date: Jul. 25, 2013

(54) PRE-INSULATED PIPING SYSTEM

(71) Applicant: Robert A. Maffei, Wheaton, IL (US)

(72) Inventor: Robert A. Maffei, Wheaton, IL (US)

(21) Appl. No.: 13/523,440

(22) Filed: Jun. 14, 2012

Related U.S. Application Data
(60) Provisional application No. 61/588,958, filed on Jan. 20, 2012.

(51) Int. Cl. F16L 59/07

(52) U.S. Cl. 138/149

(57) ABSTRACT

A pre-insulated pipe for carrying a fluid pressure has an elongated service pipe of a first length. A first insulation layer of an aerogel is wrapped about the service pipe. A metallic sleeve is wrapped about the first insulation layer such that a compressive force is exerted on the aerogel within the sleeve. The metallic sleeve has a second length less than the first length of the elongated service pipe.

### CROSS-REFERENCE TO RELATED APPLICATIONS

This Application claims the benefit of U.S. Provisional Application No. 61/588,958, filed on Jan. 20, 2012, which is incorporated by reference as if fully set forth herein.

### TECHNICAL FIELD

The present invention relates to insulation of pipes, and in particular, to a layered insulation system for a pipe comprising an aerogel.

### BACKGROUND OF THE INVENTION

Some piping systems carry underground steam, hot water or other hot fluids. One such system comprises a prefabricated, preinsulated service pipe. In this system, an outer conduit is insulated with polyurethane foam insulation and has a jacket of filament wound fiberglass or an extruded high density polyethylene jacket. A further layer of high temperature insulation, such as a mineral wool or calcium silicate, is located about the service pipe.

Another system also comprises a prefabricated, preinsulated service pipe. This system comprises an air space and a high temperature insulation, such as a mineral wool or a calcium silicate insulation, located about the service pipe.

A full discussion of the features and advantages of the present invention is deferred to the following detailed description, which proceeds with reference to the accompanying drawings.

### SUMMARY OF THE INVENTION

A first aspect of the invention is directed to a pre-insulated pipe for carrying a fluid pressure. The pre-insulated pipe comprises an elongated service pipe of a first length, a first insulation layer comprising an aerogel wrapped about the service pipe, and a metallic sleeve wrapped about the first insulation layer. The metallic sleeve exerts a compressive force on the aerogel within the sleeve and has a second length less than the first length of the elongated service pipe.

This aspect of the invention may include one or more of the following features, alone or in any reasonable combination. The pre-insulated pipe may further comprise an air gap about the first insulation layer. The pre-insulated pipe may further comprise a rigid spacer member located radially outwardly of the first insulation layer. The pre-insulated pipe may further comprise a first conduit about the first insulation layer, the service pipe, and the rigid spacer wherein the air gap is at least partially formed by communication between the rigid spacer and the first conduit. The rigid spacer member may be located within the air gap and supports the first conduit about the first insulation layer. The pre-insulated pipe may further comprise a second insulation layer about the first insulation layer and the service pipe. The second insulation layer may be located radially outwardly from the first conduit. The second insulation layer may be of an aerogel. The second insulation layer may be selected from the group consisting of a polyurethane foam and a polyisocyanurate foam. The pre-insulated pipe may further comprise a jacket located radially outwardly of the first insulation layer. The jacket may be located radially outwardly of the second insulation layer. The first conduit may be produced from a metallic material. The jacket may be produced from a group consisting of a fiberglass reinforced plastic and a thermoplastic. The pre-insulated pipe may further comprise an aluminum diffusion barrier between the second insulation layer and the jacket.

A second aspect of the present invention is directed to a pre-insulated pipe for carrying a fluid pressure. The pre-insulated pipe comprises an elongated service pipe of a first length, a first insulation layer comprising an aerogel wrapped about the service pipe, a metallic sleeve wrapped about the first insulation layer such that a compressive force is exerted on the aerogel within the sleeve wherein the metallic sleeve has a second length less than the first length of the elongated service pipe. a first conduit about the metallic sleeve, the first insulation, and the elongated service pipe having a third length greater than the second length of the metallic sleeve, an air gap between the first conduit and the first insulation layer, and a rigid spacer member between the first conduit and the first insulation and in communication therewith for providing the air gap wherein the rigid spacer disposes the elongated service pipe non-concentrically relative to the first conduit.

The second aspect of the invention may include one or more of the following features, alone or in any reasonable combination. The pre-insulated pipe may further comprise a second insulation layer about the first insulation layer and the service pipe. The second insulation layer may be located radially outwardly from the first conduit. The second insulation layer may be selected from the group consisting of a polyurethane foam and a polyisocyanurate foam. The pre-insulated pipe may further comprise a jacket located radially outwardly of the second insulation layer. The first conduit may be produced from a metallic material.

### BRIEF DESCRIPTION OF THE DRAWINGS

To understand the present invention, it will now be described by way of example, with reference to the accompanying drawings in which:

FIG. 1 is a cross-sectional view of a pre-insulated pipe system of the present invention;

FIG. 2 is a cross-sectional view of a pre-insulated pipe taken along a length of the pipe;

FIG. 3 is a cross-sectional view of a second embodiment of a pre-insulated pipe system of the present invention;

FIG. 4 is a cross-sectional view of the second embodiment taken along a length of the pipe;

FIG. 5 is a cross-sectional view of a pre-insulated pipe system of the present invention with a service pipe non-concentric with the an outer conduit;

FIG. 6 is a cross-sectional view of a pre-insulated pipe taken along a length of the pipe with a service pipe non-concentric with the an outer conduit;

FIG. 7 is a cross-sectional view of the second embodiment of a pre-insulated pipe having a service pipe non-concentric with an outer conduit; and

FIG. 8 is a cross-sectional view of the second embodiment of a pre-insulated pipe system of the present invention taken along the length of the pipe and having a service pipe non-concentric with an outer conduit.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to a pre-insulated pipe. The pre-insulated pipe comprises an insulation system that employs a layer comprising a solid material of extremely low density, produced by removing the liquid component from a conventional gel.

The pre-insulated pipe of the present invention applies to underground high temperature fluid applications such as steam and high temperature hot water or any other hot liquid or gas. Presently, these systems comprise an inner pipe to carry the fluid, a layer of high temperature insulation such as mineral wool, calcium silicate, fiberglass or cellular glass, an air space around the high temperature insulation and an outer steel casing or conduit. The inner pipe has high compression load spacers to support the inner pipe and insulation within the outer casing. The outer casing may have another layer of insulation such as polyurethane or polyisocyanurate foam and an outer jacket such as fiberglass or high density polyethylene (HDPE) to improve the thermal efficiency of the system and prevent corrosion of the steel casing.

In these systems the high temperature insulation, except for cellular glass, can absorb moisture which degrades their insulating properties and also promotes corrosion under insulation. Cellular glass does not absorb moisture but has a higher thermal conductivity (K) which requires it to have a greater thickness thus increasing the cost, and also resulting in a larger outer conduit further increasing the cost.

It is desired to have a system wherein the high temperature insulation on the inner pipe is more thermally efficient (lower K value) than the previously used insulation materials and is hydrophobic (resistant to liquid moisture). Aerogel insulation will be used to meet these criteria. The resulting thinner insulation will reduce the size of the outer conduit reducing the cost. Since these systems are installed underground the reduced size of the outer conduit will reduce the size of the trench thus also reducing the cost to install the piping system.

Note that while the discussion herein centers on pipes, it is recognized that other pipe components, such as joints, elbows, bends, tees, wyes, couplers, etc. can be insulated in the manners discussed herein.

### A Pre-Insulated Pipe 10

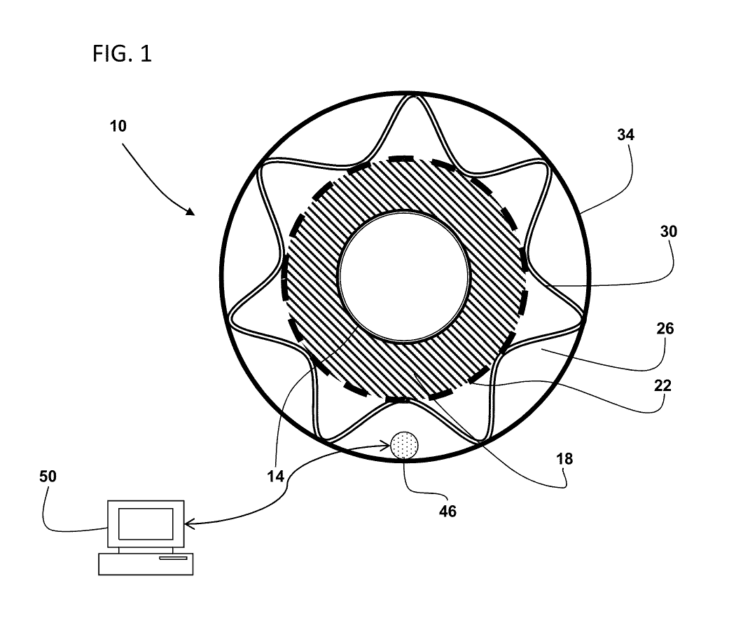

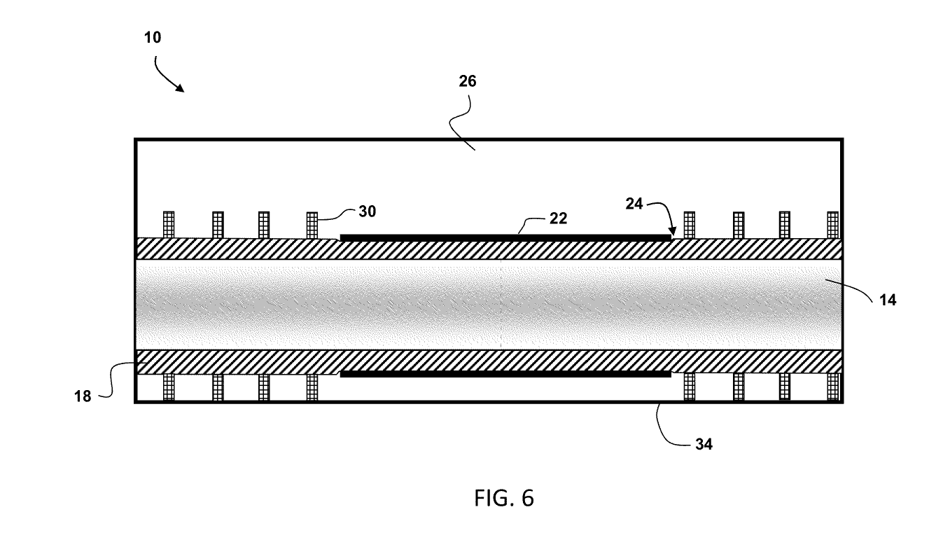

Referring generally to FIGS. 1-2 and 5-6, a pre-insulated pipe 10 of the present invention comprises a fluid conduit or service pipe 14 conventionally made of steel, has a nominal diameter of between 1″ and 72″ through a center axis and comprises an outer surface with an optional anticorrosion coating thereon and one or more insulation layers disposed on the anticorrosion coating surface. The service pipe 14 is generally an elongated member having a length on the order of several feet.

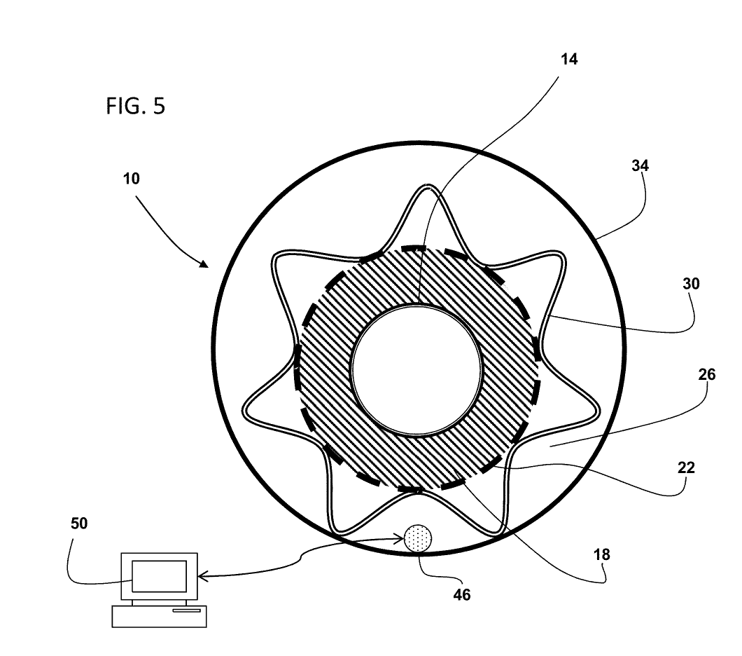

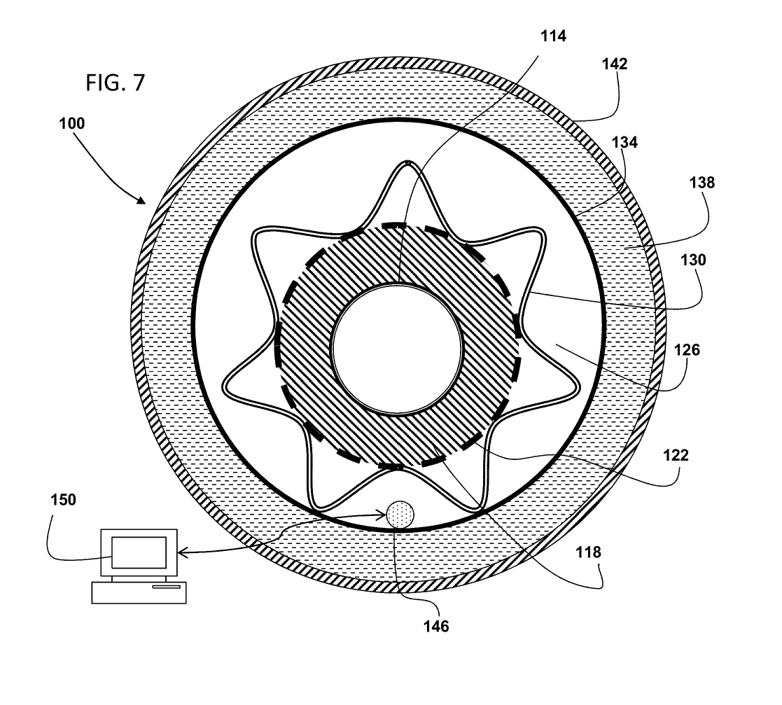

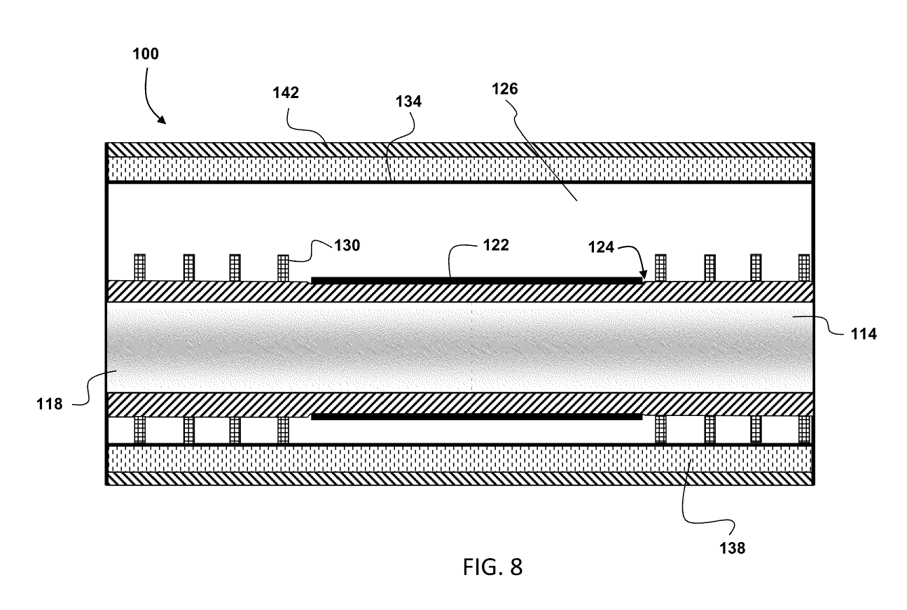

Due to the high temperature of the fluid in the inner pipe, the pipe is normally designed to move longitudinally within the outer conduit which is restrained from longitudinal growth by the soil. To allow sliding, the inner pipe, insulation and support system must be smaller in outside diameter than the inner diameter of the outer conduit. This smaller diameter will result in the inner pipe being non-concentric with the outer conduit. (See FIGS. 5-8). It is even more non-concentric in areas of changes in direction of the piping such as elbows or expansion loops. In these areas the outer conduit is frequently oversized to provide additional space for movement. In these areas, due to the change in direction, the longitudinal movement becomes lateral movement on the other side of the change in direction. The transition from the original conduit size to the oversize conduit is normally accomplished with eccentric reducers which offsets the inner pipe within the outer conduit.

Adjacent the pipe are the following layers:

### The First Layer 18—An Insulation

The pre-insulated pipe comprises a first layer 18 of a single or multiple layers of an aerogel insulation material, preferably a silica aerogel, more preferably a silica aerogel reinforced with a non-woven, glass-fiber batting such as one marketed under the trademark Pyrogel® XT by Aspen Aerogels. Inc. of Northborough, Mass. The first layer insulation 18 preferably has an insulation K factor two times less than mineral wool, three times less than calcium silicate, and four times less than perlite. Because an adequate insulation value can be achieved with less aerogel material, the diameter of the first layer insulation 18 can be less than if other materials were employed, resulting in a saving in space.

The first layer 18 is hydrophobic.

The first layer 18 takes advantage of nanotechnology. The preferred aerogel is formed from 3% silica solids with 97% air in extremely small nanopores. These characteristics make the first layer 18 the lowest known density solid and most effective insulator. It typically requires 50% to 80% less material than other high temperature insulation materials.

### The Second Layer 22—A Lagging Layer

A second layer 22 is a lagging layer. The lagging layer 22 is generally an intermittent layer in segments. Each segment extends longitudinally along a length of the service pipe 14 in support location. The lagging layer 22 generally comprises a metallic sleeve, preferably of a steel. The metallic sleeve has a length which is less than a length of the service pipe 14. For example, the lagging layer 22 may have a length on the order of one foot and repeat every ten feet or so of service pipe 14.

The lagging layer 22 provides supports for the service pipe 14 and first layer 18. It is important to maintain the thermal insulation through the lagging layer 22 to prevent areas of higher heat loss. In the prior art, these supports are normally made from insulation with high compressive strength such as calcium silicate or cellular glass. If these insulations were used for the supports in the present invention they would need to be thicker than the aerogel insulation of the first layer 18 to maintain the same insulation or heat loss value. This increased thickness would result in having to increase the size of the outer conduit 34 thus increasing the cost and losing the advantage of having a more efficient insulation on the inner pipe.

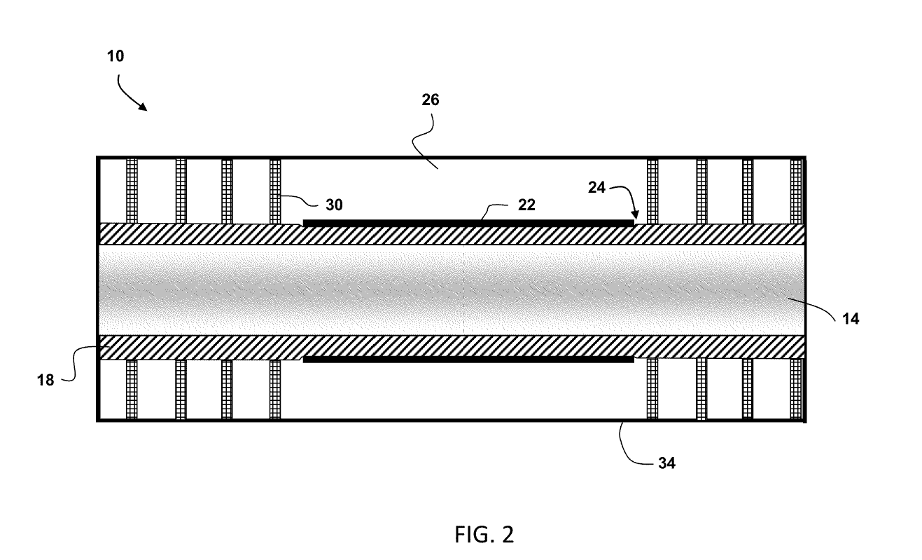

The first layer 18 of the present invention comprises an aerogel insulation which has a low compressive strength, but the compressive strength increases as the aerogel is compressed. Therefore supports can be made from aerogel by pre-compressing the aerogel to increase its compressive strength. One way to make the supports is to wrap a lagging layer 22 of a steel sleeve around the aerogel of the first layer 18 at support locations and tighten it to compress the aerogel. Accordingly, the lagging layer 22 exerts a radially inwardly compressive force on a length of the aerogel. A compressed portion 24 of the aerogel is illustrated on FIG. 2. A length of the compressed portion 24 coincides approximately with the length of the metallic sleeve of the lagging layer 22 and is, therefore, less than the length of the service pipe. An important feature of the aerogel insulation is that the insulating K value improves when it is compressed. For other insulations the insulation K value deteriorates as the insulation is compressed.

### The Third Layer 26—Air Gap

The third layer 26 is an air gap. A rigid spacer 30 is supplied in the air gap 26 to support a fourth layer 34 about the inner layers 14,18. The rigid spacer 30 is preferably a corrugated structure wrapped about the inner layers 14,18 and in communication with a radially inner surface of the fourth layer 34 and the first layer 18 or the lagging layer 22.

### The Fourth Layer 34—A Conduit Layer

The fourth layer 34 is a tubular conduit through which the inner layers 14,18 pass and are supported within. The conduit is preferably produced from a metallic material, more preferably steel. Like the service pipe 14, the outer conduit 34 may be coated, preferably with a corrosion resistant coating, such as epoxy or zinc.

### Leak Detection

The pipe 10 can be equipped with an advanced electronic monitoring system. The system comprises a leak detection cable 46 in communication with a control unit 50. The leak detection system provides full time monitoring of the performance of the pre-insulated pipe 10. The monitoring system senses the presence of moisture within the air gap or third layer 26. the system ensures that the pipe 10 was installed dry and stays dry.

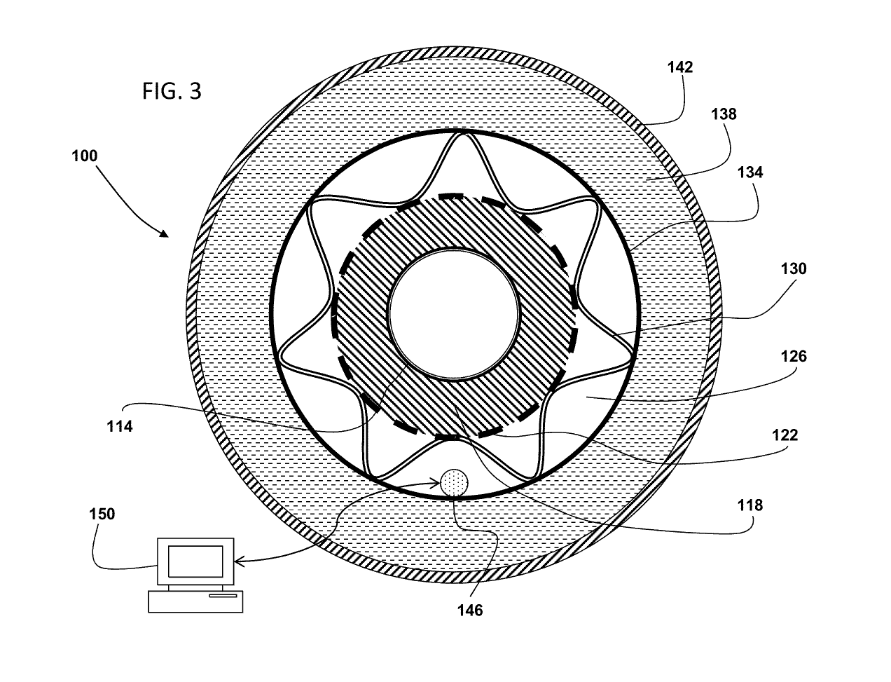

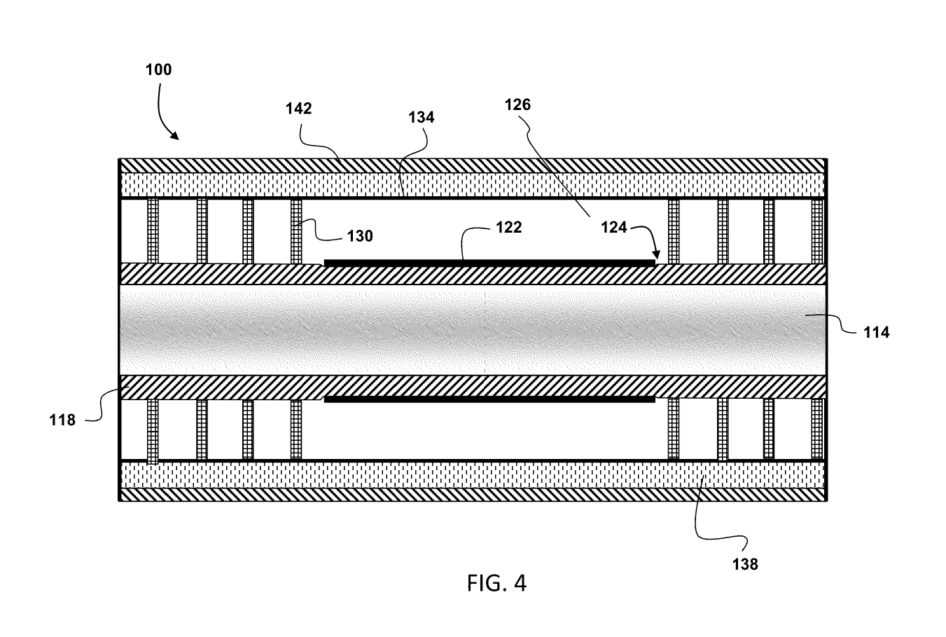

A second embodiment is illustrated generally in FIGS. 3-4 and 7-8. The elements of the second embodiment are for the most part identical to the elements of the first embodiment with the exceptions set forth below. Accordingly for simplicity, the elements of the second embodiment are given reference numerals 100 numbers higher than the corresponding elements of the first embodiment. For example, the first pre-insulated pipe is given the reference numeral 10 and the second pre-insulated pipe is given the reference numeral 100. Also, the first service pipe is 14 and the second service pipe is 114.

The second pre-insulated pipe 100 includes the following additional elements.

### A Fifth Layer 138—An Insulation

The pre-insulated pipe 100 includes a layer of insulation 138 about the conduit layer 134. This insulation layer 138 may be of an aerogel as previously described but is more preferably a polyurethane or polyisocyanurate foam. There may be an aluminum diffusion barrier between the fifth layer 138 and the sixth layer 142. This diffusion barrier prevents diffusion of a blowing agent during application of the polyurethane or polyisocyanurate to the sixth layer 142 and results in an improved long term thermal efficiency of at least 25%.

### A Sixth Layer 142—A Jacket

A jacket 142 is applied to the outer surface of the insulation layer 138. A typical jacket is a high density polyethylene coating (HDPE) which is extruded around the insulated pipe and tubular in structure. However, more preferably, the jacket is a fiberglass reinforced plastic (FRP) or a thermoplastic.

As used herein, the terms “first,” “second,” “third,” etc. are for illustrative purposes only and are not intended to limit the embodiments in any way. Additionally, the term “plurality” as used herein is intended to indicate any number greater than one, either disjunctively or conjunctively as necessary, up to an infinite number. The term “communication” is intended to encompass both direct engagement with an element and engagement through intermediate elements. The term “jacket” refers to a tubular or substantially tubular member wrapped or formed about radially inner layers. The term “sleeve” refers to any structural element that can place a compressive force about the circumference of an aerogel insulation layer, preferably, but not limited to, a metallic tubular structure, typically a cylindrical steel member.

While the specific embodiments have been illustrated and described, numerous modifications come to mind without significantly departing from the spirit of the invention, and the scope of protection is only limited by the scope of the accompanying Claims.

What is claimed is:

1. A pre-insulated pipe for carrying a fluid pressure comprising:
an elongated service pipe of a first length;
a first insulation layer comprising an aerogel wrapped about the service pipe; and
a metallic sleeve wrapped about the first insulation layer such that a compressive force is exerted on the aerogel within the sleeve wherein the metallic sleeve has a second length less than the first length of the elongated service pipe.

2. The pre-insulated pipe of claim 1 further comprising:
an air gap about the first insulation layer.

3. The pre-insulated pipe of claim 2 further comprising:
a rigid spacer member located radially outwardly of the first insulation layer.

4. The pre-insulated pipe of claim 3 further comprising:
a first conduit about the first insulation layer, the service pipe, and the rigid spacer wherein the air gap is at least partially formed by communication between the rigid spacer and the first conduit.

5. The pre-insulated pipe of claim 4 wherein the rigid spacer member is located within the air gap and supports the first conduit about the first insulation layer.

6. The pre-insulated pipe of claim 5 further comprising:
a second insulation layer about the first insulation layer and the service pipe.

7. The pre-insulated pipe of claim 6 wherein the second insulation layer is located radially outwardly from the first conduit.

8. The pre-insulated pipe of claim 7 wherein the second insulation layer is of an aerogel.

9. The pre-insulated pipe of claim 7 wherein the second insulation layer is selected from the group consisting of a polyurethane foam and a polyisocyanurate foam.

10. The pre-insulated pipe of claim 6 further comprising:
a jacket located radially outwardly of the first insulation layer.

11. The pre-insulated pipe of claim 10 wherein the jacket is located radially outwardly of the second insulation layer.

12. The pre-insulated pipe of claim 11 wherein the first conduit is produced from a metallic material.

13. The pre-insulated pipe of claim 11 wherein the jacket is produced from a group consisting of a fiberglass reinforced plastic and a thermoplastic.

14. The pre-insulated pipe of claim 10 further comprising an aluminum diffusion barrier between the second insulation layer and the jacket.

15. A pre-insulated pipe for carrying a fluid pressure comprising:
an elongated service pipe of a first length;
a first insulation layer comprising an aerogel wrapped about the service pipe;
a metallic sleeve wrapped about the first insulation layer such that a compressive force is exerted on the aerogel within the sleeve wherein the metallic sleeve has a second length less than the first length of the elongated service pipe;
a first conduit about the metallic sleeve, the first insulation, and the elongated service pipe having a third length greater than the second length of the metallic sleeve
an air gap between the first conduit and the first insulation layer; and
a rigid spacer member between the first conduit and the first insulation and in communication therewith for providing the air gap wherein the rigid spacer disposes the elongated service pipe non-concentrically relative to the first conduit.

16. The pre-insulated pipe of claim 15 further comprising:
a second insulation layer about the first insulation layer and the service pipe.

17. The pre-insulated pipe of claim 16 wherein the second insulation layer is located radially outwardly from the first conduit.

18. The pre-insulated pipe of claim 17 wherein the second insulation layer is selected from the group consisting of a polyurethane foam and a polyisocyanurate foam.

19. The pre-insulated pipe of claim 18 further comprising:
a jacket located radially outwardly of the second insulation layer.

20. The pre-insulated pipe of claim 19 wherein the first conduit is produced from a metallic material.
